(19) United States
(12) Patent Application Publication
(10) Pub. No.: US 2025/0039334 A1
(43) Pub. Date: Jan. 30, 2025

(54) COLLABORATION USING CONVERSATIONAL ARTIFICIAL INTELLIGENCE DURING VIDEO CONFERENCING

(71) Applicant: Zoom Video Communications, Inc., San Jose, CA (US)

(72) Inventors: Evgeny Balashov, Burbank, CA (US); Christopher Allen Alexander Goodine, Ajax (CA); Arun Janakiraman, San Francisco, CA (US); Ross Douglas Mayfield, Palo Alto, CA (US)

(21) Appl. No.: 18/361,397

(22) Filed: Jul. 28, 2023

(51) Int. Cl. H04N 7/15

(52) U.S. Cl. CPC H04N 7/152; H04N 7/155

(57) ABSTRACT

Techniques for using collaborative conversational artificial intelligence during video conferencing are provided. In an example method, a video conference provider joins first and second client devices to a video conference. The video conference provider receives, from the first client device, a first prompt and relays the first prompt to a conversational AI, which is followed by receipt of a first response. The video conference provider then outputs, to the second client device, a data structure including information about the first prompt and the first response. In some examples, the video conference provider receives, from the second client device, a second prompt and relays the second prompt to the conversational AI, which is followed by receipt of a second response. The video conference provider then outputs, to the first client device, a data structure including information about the second prompt and the second response.

### FIELD

The present application generally relates to video conferencing, and more particularly relates to techniques for collaboration using conversational artificial intelligence during video conferencing.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides videoconferencing functionality to various client devices.

FIG. 2 shows an example system in which a video conference provider provides videoconferencing functionality to various client devices.

FIG. 3 shows an example of a system for using collaborative conversational artificial intelligence (AI) during video conferencing, according to some aspects of the present disclosure.

FIG. 4 shows an example of a system for using collaborative conversational AI during video conferencing, according to some aspects of the present disclosure.

FIG. 5 shows an illustration of an example GUI that may be used with a system for providing collaborative conversational AI during video conferencing, according to some aspects of the present disclosure.

FIGS. 6A-B show a flowchart of an example method for providing services for collaborative conversational AI during video conferencing, according to some aspects of the present disclosure.

FIG. 7 shows an example computing device suitable for use in example systems or methods for providing collaborative conversational AI during video conferencing, according to some aspects of the present disclosure.

### DETAILED DESCRIPTION

Examples are described herein in the context of techniques for collaboration using conversational artificial intelligence during video conferencing. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

While video conferencing technologies are by now a core component of personal and enterprise communications, constellations of ancillary technologies continue to take root to improve on the collaborative capabilities of these platforms. For example, artificial intelligence (AI) technologies growing alongside the flourishing vistas of video conferencing technologies have opened new doors for such capabilities as real-time annotations, AI-assisted scheduling, summarization, sentiment analysis, translation, among many others.

One powerful example of such an AI technology is a conversational AI. Conversational AI includes technologies designed to simulate human-like conversational interactions. For example, using a conversational AI tool, a user can ask the tool questions about a subject or problem, as if the tool were a person, and receive responses that may be indistinguishable from responses that would be received from a human interlocutor in similar circumstances. While the range, scope, and accuracy of the responses of the conversational AI may be limited, it may nevertheless be useful for a number of purposes, including creative purposes. Example applications include responding to knowledge questions (e.g., acting like a search engine), content creation, customer service, preliminary diagnostic tools in the healthcare context, powering interactive characters in video games or virtual reality, and so on.

Conversational AI may be used to in the context of remote collaboration, which is among the most powerful capabilities enabled through now-ubiquitous video conferencing. Through remote collaboration, geographically disparate teams can develop ideas and projects in real-time with minimal cost. Some conversational AI tools can be used during collaborative team sessions using basic facilities like screen sharing or audio narration.

However, existing interfaces for conversational AI tools may reside on only a single client device that may not be well-suited for collaboration. For example, a conversational AI tool that resides only on a single client device can likewise only be operated by a single user. At best, the interface can be shared during a video conference, leaving one participant to act as scribe and leaving other participants unable to review previous portions of the dialogue, to discern authorship, or review history. Thus, while the conversational AI has the potential to improve the collaborations possible through video conferencing, existing tools and methods provide a poor user experience and ultimately make real-time collaboration using such tools difficult and only useful during later review.

Techniques are provided for using collaborative conversational AI during video conferencing. An example method begins with a video conference provider hosting a video conference including at least two client devices. Among the client devices are a first client device and a second client device. Each participating client device has an associated participant (e.g., a user). The video conference provider may provide video conferencing client software for use by the various participating client devices. The video conferencing client software may include a user interface for the video conference participants to collaborate using a conversational AI during the video conference.

To facilitate collaboration using the conversational AI, the video conference provider accesses a conversational AI. The conversational AI may be, for example, a transformer-based large language model (LLM). A transformer-based LLM is a type of conversational AI that can be trained on large volumes of textual training data to develop statistical models that can generate human-like responses given arbitrary, free-form questions, referred to as prompts. For instance, the transformer-based LLM may be a generative pre-trained transformer (GPT) model. In some examples, the conversational AI may be one provided by a third-party software provider such as ChatGPT. ChatGPT is a typical example of a conversational AI that can provide a chat-like interaction with a LLM for human participants. In this example method, the video conference provider can send information to the conversational AI based on the inputs of the participants, receive responses, and provide information to the client devices necessary to show a collaborative, chat-like interface to the participants.

In this example, the video conference provider receives, from the first client device, a prompt intended for the conversational AI submitted by a participant using the first client device. For example, the video conferencing client software may include a user interface that can receive a prompt typed or spoken by the participant. The first client device sends the prompt to the video conference provider, on behalf of the participant.

The video conference provider then relays the prompt to the conversational AI. For example, the conversational AI may provide a web-based representational state transfer (REST) application programming interface (API) that accepts prompts as inputs and returns responses from the conversational AI. The conversational AI may process and interpret the prompt and generate an appropriate response based on its training data.

In parallel, the video conference provider outputs, to the second client device, a data structure comprising information about the prompt submitted by participant using the first client device. The video conferencing client software executing on the second client device receives the data structure and may render a user interface that displays the prompt submitted by the participant using the first client device in a collaborative chat-like interface, including an indication that the prompt was submitted by participant using the first client device. For example, the user interface displayed by the second client device may show an icon or other graphic that corresponds to the participant alongside the prompt.

The video conference provider then receives, from the conversational AI, a response responsive to the submitted prompt. For example, the prompt submitted to the REST API of the conversational AI may receive a response that includes a response to the prompt submitted by the user of the first client. The response may include text, graphics, audio, etc. and may be responsive to the prompt submitted by the participant using the first client device.

The video conference provider then outputs, to the second client device, another data structure including information about the response. As with the prompt, the video conferencing client software executing on the second client device receives the data structure and may generate a user interface that displays the response in relation to the prompt submitted by the participant using the first client device in the collaborative chat-like interface, including an indication that the response is responsive to the prompt, evocative of a conversation or chat dialogue. For example, in the chat-like user interface, the response may be shown below the prompt, along with an indication like an icon or other graphic indicating the both the prompt and the response are associated with the participant using the first client device. Updates to the chat-like interface on the second client device may be shown in real-time, as the prompt is entered or as the response is received, so that the participants can collaborate during the video conference with the conversational AI as a shared basis for their collaboration.

In some examples, the mirror image process can also be performed, except that now the participant using the second client device is interacting with the conversational AI using a user interface provided by the video conferencing client software executed by the second client device. The video conference provider receives, from the second client device, a prompt. The video conference provider outputs, to the first client device, a data structure including information about the prompt. The video conference provider relays the prompt received from the second client device to the conversational AI. The video conference provider receives, from the conversational AI, a response responsive to the prompt. The video conference provider outputs, now to the first client device, a data structure including information about the response to the prompt submitted by the participant using the second client device.

For example, in the chat-like user interface, the response may again be shown below the prompt, along with an indication like an icon or other graphic indicating the both the prompt and the response are associated with the participant using the second client device. Further, the prompt submitted by the participant using the second client device and its associated response may be shown after the prompt submitted by the participant using the first client device and its associated response to indicate a chronological relationship that corresponds to the collaboration between the participants. The chat-like interface may shown simultaneously on all participating client devices in real-time, as the prompt is entered and as the response is received, so that all participants, can collaborate during the video conference with the conversational AI as a shared basis for their collaboration.

The innovations of the present disclosure provide significant improvements in the field of video conferencing technology. Conversational AI technologies can be a powerful collaborative tool, but such tools may be hampered in the context of a video conference due to a lack of a shared collaborative interface for video conference participants. Thus, prior to the innovations of the present disclosure, collaboration involving conversational AI technologies relied on manually relaying prompts and responses, screen sharing, audio narration, or sharing transcripts. The user experience was often poor, as traditional interfaces lack any indication of who submitted which prompts, to which responses prompts were directed, or any indication of the chronological ordering of the collaborative process with respect to the conversation.

The techniques disclosed herein for collaborative conversational artificial intelligence during video conferencing eliminate the need for the awkward, manual processes traditionally used for collaboration and provide a seamless user experience. For example, a shared collaborative interface may be displayed on all participating client devices. The interface may update in real-time, provide a local copy for all participants, and include customizable indications of the originator of each prompt, associated response, as well as other comments, annotations, and so on. The chat-like interface enforces a chronological ordering of the elements of the conversation with the conversational AI, which may, along with timestamps, provide an indication of the logical ordering of the collaboration as it unfolds. The user experience is improved because, among other things, participants no longer need to convey prompts audibly or textually to an operator and can instead compose prompts locally with due care prior to submission. Moreover, the timeliness and relevance of submitted prompts may be improved due to participant authors having the most up to date information available before submitting prompts.

Collaboration using conversational AI may be further enhanced by the retention of and use of prior context by the conversational AI. The record of the collaboration can be maintained by the conversational AI and all responses may be given in the context of previous prompts and responses. Newly instantiated conversations can be sent the content of previous conversations so that subsequent collaborations can proceed in the context of existing ones.

These illustrative examples are given to introduce the reader to the general subject matter discussed herein and the disclosure is not limited to these examples. The following sections describe various additional non-limiting examples and examples of techniques for collaborative conversational artificial intelligence during video conferencing.

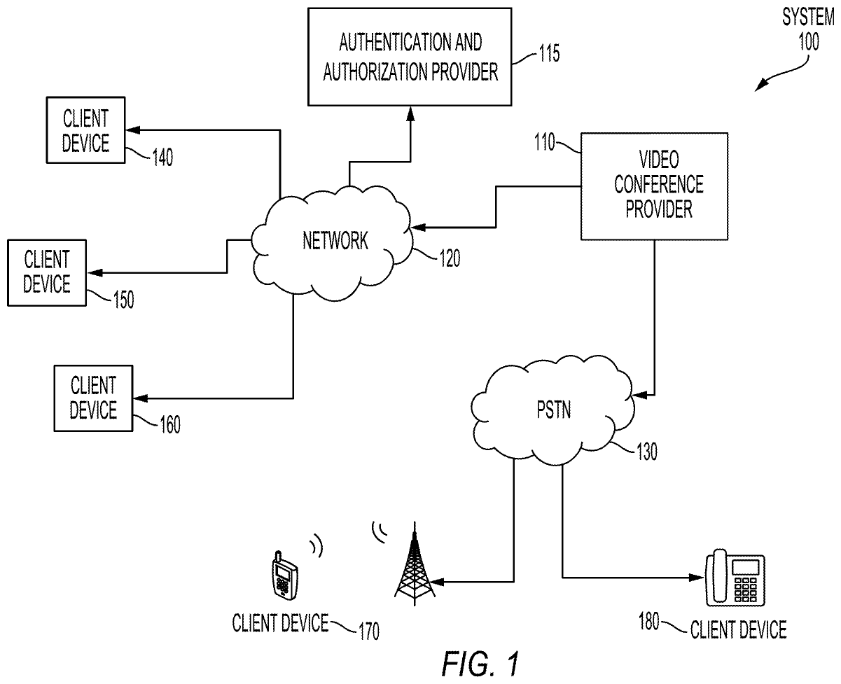

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a video conference provider 110 may supply components to enable a private organization to host private internal video conferences or to connect its system to the chat and video conference provider 110 over a public network.

The system optionally also includes one or more user identity providers, e.g., user identity provider 115, which can provide user identity services to users of the client devices 140-160 and may authenticate user identities of one or more users to the chat and video conference provider 110. In this example, the user identity provider 115 is operated by a different entity than the chat and video conference provider 110, though in some examples, they may be the same entity.

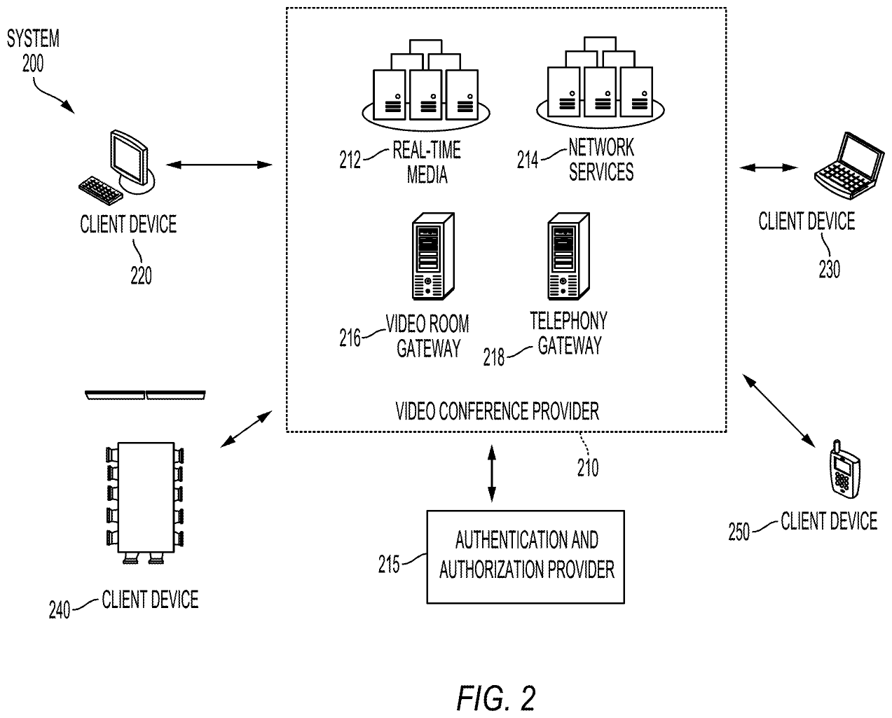

Video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the chat and video conference provider 110.

A user identity provider 115 may be any entity trusted by the chat and video conference provider 110 that can help identify a user to the chat and video conference provider 110. For example, a trusted entity may be a server operated by a business or other organization with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the chat and video conference provider 110.

When the user accesses the chat and video conference provider 110 using a client device, the chat and video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide user identification information to identify the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the chat and video conference provider 110, even in cases where the user has an authenticated identity and employs a client device capable of identifying the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more user identity providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting a user identity provider 215 to verify the provided credentials. Once the user's credentials have been accepted, the network services servers 214 may perform administrative functionality, like updating user account information, if the user has an identity with the chat and video conference provider 210, or scheduling a new meeting, by interacting with the network services servers 214.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

In some embodiments, in addition to the video conferencing functionality described above, the chat and video conference provider 210 (or the chat and video conference provider 110) may provide a chat functionality. Chat functionality may be implemented using a message and presence protocol and coordinated by way of a message and presence gateway 217. In such examples, the chat and video conference provider 210 may allow a user to create one or more chat channels where the user may exchange messages with other users (e.g., members) that have access to the chat channel(s). The messages may include text, image files, video files, or other files. In some examples, a chat channel may be “open,” meaning that any user may access the chat channel. In other examples, the chat channel may require that a user be granted permission to access the chat channel. The chat and video conference provider 210 may provide permission to a user and/or an owner of the chat channel may provide permission to the user. Furthermore, there may be any number of members permitted in the chat channel.

Similar to the formation of a meeting, a chat channel may be provided by a server where messages exchanged between members of the chat channel are received and then directed to respective client devices. For example, if the client devices 220-250 are part of the same chat channel, messages may be exchanged between the client devices 220-240 via the chat and video conference provider 210 in a manner similar to how a meeting is hosted by the chat and video conference provider 210.

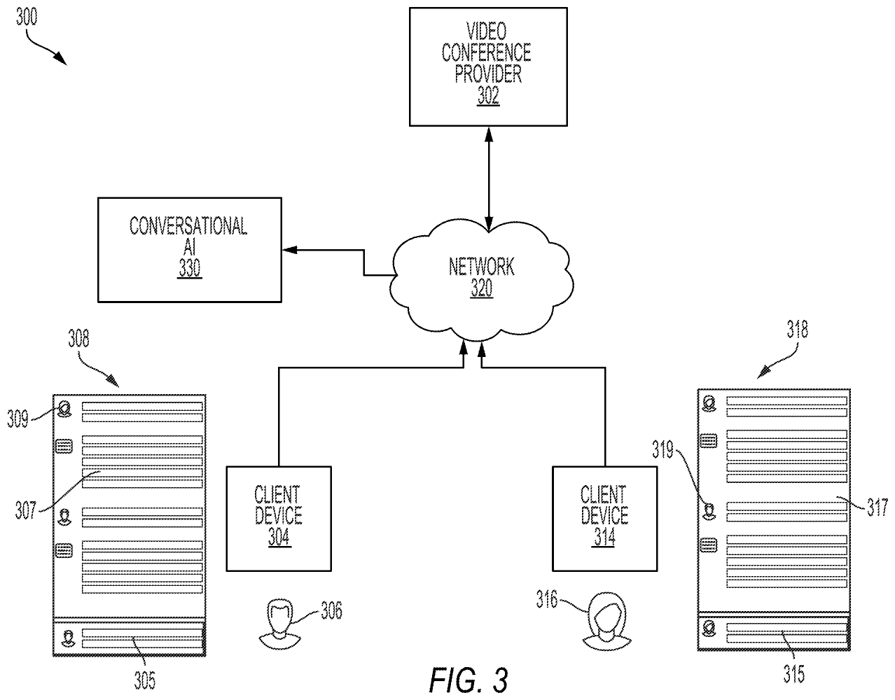

Referring now to FIG. 3, FIG. 3 shows an example of a system 300 for using collaborative conversational artificial intelligence (AI) during video conferencing, according to some aspects of the present disclosure. One or more client devices 304, 314 are communicatively coupled with a video conference provider 302. For example, the client devices 304, 314 may be coupled to the video conference provider 302 over a network 320. The network 320 can include public networks, private networks, the Internet, or any other suitable combination of networked devices. For example, the client devices 304, 314 may communicate with the video conference provider 302 over network 320 by establishing a TCP/IP or a UDP/IP connection to facilitate the exchange of packets between client applications (e.g., video conferencing software) and one or more servers hosted by video conference provider 302.

In example system 300, the video conference provider 302 hosts a video conference with one or more participating client devices 304, 314. A plurality of client devices and their associated video conference participants may join together to participate in a video conference. For instance, example system 300 depicts two client devices 304, 314 with participants 306, 316 participating in a video conference. A video conference may include the video and audio streams of each participant being sent from each respective client device to the video conference provider 302 and then to the client devices 304, 314 of the remaining participants.

Turning now to a particular client device 304, the client device 304 may be a personal computer, laptop, smartphone, tablet, or similar device. Client device 304 may include a display device and one or more input devices. Client device 304 may also include video conferencing software for conducting video conferences. The client device 304 may have a video conference participant 306, sometimes referred to as the user of the client device 304.

Conversational AI 330 may be an AI system configured to designed to enable processing devices to engage in human-like conversation. In one example, conversational AI 330 systems may include rule-based program code for using a predefined set of rules or decision trees to guide chat interactions. For example, rule-based conversational AI 330 can analyze user input based on specific keywords, phrases, or patterns to generate corresponding responses.

In another example, conversational AI 330 can include intent recognition systems. Intent recognition systems may be based on machine learning (ML) models that have been trained to categorize inputs into various intents. Intent recognition systems can converse based on a wide range of user input and can be used in, for example, virtual assistant applications to perform tasks like setting reminders and performing search queries. The ML models underlying intent recognition systems are typically trained using significant amounts of labeled training data and computational power.

Conversational AI 330 may include contextual systems that can maintain a conversation and base responses on past and present context. For example, conversational AI 330 may be based on a large language model (LLM). A LLM can include AI models that have been trained on large amounts of unlabeled text data (e.g., a diverse collection of books, websites, articles, and other textual content including billions of words or more). LLMs may be designed to generate human-like text by “understanding” and responding to prompts by providing relevant outputs. Notable examples of LLMs include Generative Pre-trained Transformer (GPT)-3 or -4, Language Model for Dialogue Applications (LaMDA), BigScience Large Open-science Open-access Multilingual Language Model (BLOOM), Language Learning with Mini-Adapters (LLaMA), and others.

Some LLMs may include a transformer neural network. The transformer neural network may include one or more layers that include a self-attention mechanism in addition to one or more feed-forward neural networks. The self-attention mechanism, sometimes referred to as multi-head attention, gives the model the ability to “focus” on different parts of the input sequence, providing a specific context for the interpretation of each word. The context for each word can be obtained, for example, by calculating an attention score for each word in relation to all other words in the sequence. The attention score may be, for example, a weighted representation of the sequence that highlights the interdependencies between words. In some examples, the self-attention mechanism can process inputs in parallel, which enables some transformer-based models to handle significantly longer input sequences.

The feed-forward neural networks subsequently process each position in the input sequence independently. The feed-forward neural networks may introduce non-linearity into the model, which may enable the model to capture complex patterns in the data. For example, the non-linearity can be introduced by way of an activation function like the rectified linear unit (ReLU) or the hyperbolic tangent (tanh) within the network. The feed-forward neural networks may include a linear combination of weights and biases that can be trained to allow the model to learn higher-order interactions between the input features received from the self-attention mechanism such as complex grammatical structures, long-range dependencies between words, or subtle semantic meanings.

Conversational AI 330 may include contextual systems that can maintain a conversation and base responses on past and present context. For example, conversational AI 330 may be based on a large language model (LLM). A LLM can include AI models that have been trained on large amounts of unlabeled text data (e.g., a diverse collection of books, websites, articles, and other textual content including billions of words or more). LLMs may be designed to generate human-like text by “understanding” and responding to prompts by providing relevant outputs. Notable examples of LLMs include Generative Pre-trained Transformer (GPT)-3 or -4, Language Model for Dialogue Applications (LaMDA), BigScience Large Open-science Open-access Multilingual Language Model (BLOOM), Language Learning with Mini-Adapters (LLaMA), and others.

Some LLMs may include a transformer neural network. The transformer neural network may include one or more layers that include a self-attention mechanism in addition to one or more feed-forward neural networks. The self-attention mechanism, sometimes referred to as multi-head attention, gives the model the ability to “focus” on different parts of the input sequence, providing a specific context for the interpretation of each word. The context for each word can be obtained, for example, by calculating an attention score for each word in relation to all other words in the sequence. The attention score may be, for example, a weighted representation of the sequence that highlights the interdependencies between words. In some examples, the self-attention mechanism can process inputs in parallel, which enables some transformer-based models to handle significantly longer input sequences.

The feed-forward neural networks subsequently process each position in the input sequence independently. The feed-forward neural networks may introduce non-linearity into the model, which may enable the model to capture complex patterns in the data. For example, the non-linearity can be introduced by way of an activation function like the rectified linear unit (ReLU) or the hyperbolic tangent (tanh) within the network. The feed-forward neural networks may include a linear combination of weights and biases that can be trained to allow the model to learn higher-order interactions between the input features received from the self-attention mechanism such as complex grammatical structures, long-range dependencies between words, or subtle semantic meanings.

In an example interaction with a conversational AI 330 based on an LLM, a prompt may include the text “How does photosynthesis work in plants?” Upon receipt of the prompt, the conversational AI 330 interprets and processes it, then generates a response based on its training on its training data and using the self-attention mechanism. The conversational AI 330 may respond with a detailed explanation of the photosynthetic process. Subsequently, if a follow-up prompt includes related content, like “And how does this process differ in aquatic plants?” the conversational AI 330 can use the context of the previous prompt and response to formulate the next response. Thus, the conversational AI 330 can maintain a context-aware conversation over multiple exchanges. In some examples, the conversational AI 330 can incorporate the context of previous conversations into new conversations.

Video conference provider 302 can access an interface of the conversational AI 330. For example, conversational AI 330 may include a web-based API for receiving prompts and returning responses. The web-based API may be use various suitable patterns such as REST, graph query language (GraphQL), or simple object access protocol (SOAP).

Participants 306, 316 may submit prompts to video conference provider 302 which can relay them to the conversational AI 330. Upon receipt of a response for each prompt, the video conference provider 302 can provide a data structure to each client device 304, 314 participating in the collaborative conversation with conversational AI 330 for updating a user interface that reflects the prompts and response of the participants 306, 316 in real-time or near real-time.

For example, the user interface may be included in one or more sub-functions or application that execute in the context of the client software. For example, one such application may include a chat-like interface for collaborative conversational AI during video conferencing. For instance, in FIG. 3, client devices 304, 314 are shown with a portion of an example chat-like interfaces 308, 318 for collaborative conversational AI during video conferencing. A detailed example of a chat-like user interface is shown in FIG. 5 and the accompanying description.

Chat-like interfaces 308, 318 can be used to collaboratively interact with a conversational AI 330 during a video conference. In this respect, “collaboratively interact” refers to an interface that shows in real-time the interactions of all participants with the conversational AI 330, along with indications of which participants the respective interactions are associated with.

For example, example chat-like interfaces 308, 318 are identical except for their respective input boxes 305, 315. Both chat-like interfaces include a history section 307, 317 that reflects the shared collaborative context (e.g., the conversation or chat dialogue history). Each participant can see the same copy of the history sections 307, 317 in real-time, as new prompts are submitted to and new responses are received from the conversational AI 330. The history sections 307, 317 include indications, such as icons 309, 319 indicating which participant (e.g., 306 or 316) submitted a particular prompt. Each prompt is followed by a response from the conversational AI 330. Participants 306, 316 can submit new prompts to conversational AI 330 at any time during the collaboration, which will be immediately reflected in the history sections 307, 317 of the other participants 306, 316.

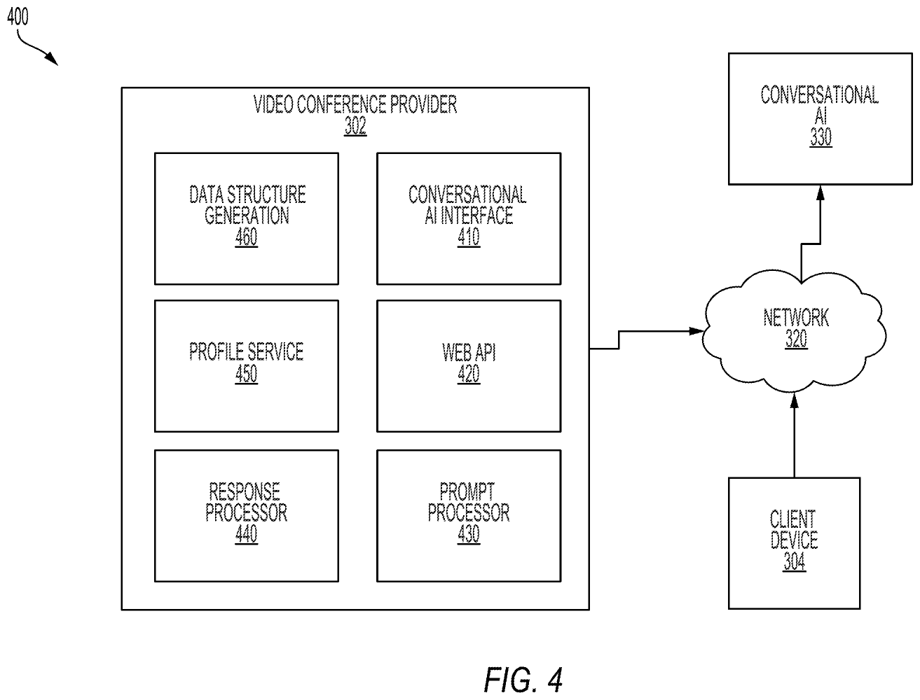

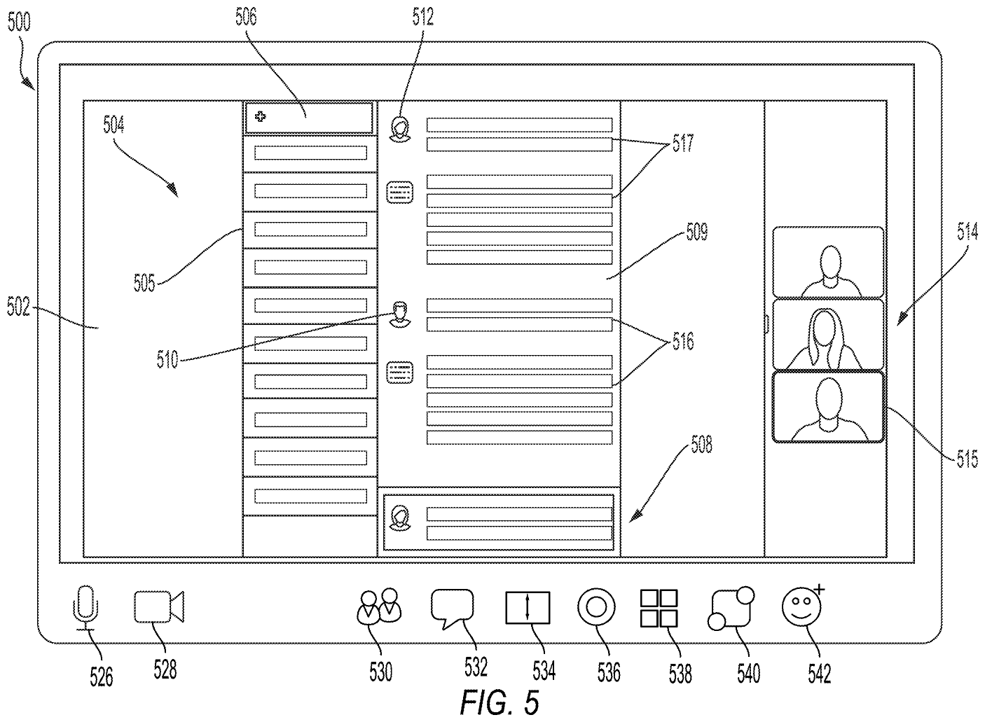

Referring now to FIG. 4, FIG. 4 shows an example of a system 400 for using collaborative conversational AI during video conferencing, according to some aspects of the present disclosure. System 400 depicts an example implementation of video conference provider 302 hosting a video conference over network 320 while providing services for collaborative conversational AI during video conferencing. The video conference may have one or more participants, including the participant using client device 304. The video conference provider 302 may be similar to the video conference provider 110, 210 described in FIGS. 1 and 2. The components of the video conference provider 302 may be implemented as hardware, software, or both.

The video conference provider 302 may be used for planning, hosting, coordination of, and securing video conferences among a plurality of participants, among other functions. The video conference provider 302 receives audio and video streams corresponding to ongoing video conferences from client device 304 and relays it to other participating client devices of the other video conference participants for playback. In some examples, some components included in video conference provider 302 may be hosted in other devices or remote servers. For example, modules or applications included in the profile service 450 may be hosted in whole or in part at a third-party identity provider or cloud computing provider.

System 400 includes client device 304. Client device 304 may be a laptop, desktop, smartphone, tablet, video conferencing room hardware, and so on. The subsystems and modules making up the client device 304 described herein may be implemented as hardware, software, or both. Typical client device 304 implementations may include a display device and input device suitable for interaction with video conferencing client software. The video conferencing client software may include functionality for participating in video conferences, chat communications, email, calendaring, among many other possible functions. Configurations and user interfaces relating to video conferencing and collaborative conversational AI during video conferencing can be viewed and input using client device 304 by way of a graphical user interface (GUI). An example GUI is shown in FIG. 5 and the accompanying description.

System 400 includes web API 420. Client device 304 can request actions or data from video conference provider 302 via web API 420. Similarly, video conference provider 302 can provide status information or query results to client device 304 in response to web API 420 communications. For example, the web API 420 may be used to receive conversational AI 330 prompts from client device 304. Alternatively, client device 304 can query video conference provider 302 for responses for particular prompts using web API 420. The web API 420 may use REST, simple object access protocol (“SOAP”), Graph Query Language (“GraphQL”), remote method invocation, or other suitable implementation for sending and receiving data from client device 304, other client devices, or other third-party applications.

System 400 includes a conversation AI interface 410. Conversational AI interface 410 can send and receive conversational information to and from conversational AI 330. Conversational AI interface 410 thus provides a means by which the video conference provider can access the conversational AI 330. For example, conversational AI interface 410 may receive a prompt from a first participant via web API 420 and relay the prompt to the conversational AI 330. Conversational AI 330 may, for example, provide an API for receiving prompts from users of the conversational AI 330. For example, conversational AI 330 may provide a web-based REST API for receiving prompts and providing responses. In some examples, conversational AI interface 410 may await the response in a single API request or may alternatively receive information for retrieving the response asynchronously at a later time with another API request. For example, the API of conversational AI 330 may provide a request ID or similar identifier that can be used later to retrieve the response, or it may be returned using an asynchronous mechanism such as WebSockets or a webhook. An asynchronous request/response paradigm is particularly important when the response is long or may take several minutes to generate.

System 400 includes a prompt processor 430. Prompt processor 430 receives prompts from client device 304 via web API 420 and prepares them for transmission to conversational AI 330 via conversational AI interface 410. For example, received prompts may be processed to remove whitespace and stripped of characters or strings that may raise security or other concerns. For example, characters or strings may be removed to prevent SQL injection attacks or to remove offensive language, according to configurations implemented by organizational administrators. Prompts may be temporarily or persistently stored in a suitable memory device included in the data structure generation 460 component, along with information associating the prompt with a particular participant, video conference, client device 304, and so on.

Similarly, system 400 includes a response processor 440. Response processor 440 receives responses from conversational AI 330 via conversational AI interface 410 and prepares them for display on client device 304. For example, received responses may be processed to remove whitespace and stripped of characters or strings that may raise security or other concerns. For example, characters or strings that relate to privacy and confidentiality may be removed, according to configurations implemented by organizational administrators. Received responses may also be augmented with formatting to improve accessibility. Responses may be temporarily or persistently stored in a suitable memory device included in the data structure generation 460 component, along with information associating the response with a particular prompt, participant, video conference, client device 304, and so on.

System 400 includes a profile service 450. Profile service 450 can be used to associate profile information with prompts and responses for display on client device 304. For example, client device 304 may include a GUI to display a chat-like interface portraying the collaboration with the conversational AI 330 using a chronological listing of prompts and associated responses. The collaborative value is enhanced through visual or contextual indications of which participants generated particular prompts and therefore associated responses. Therefore, the GUI may include icons, names, handles, or other visual indications of the author of a given prompt. The GUI may include controls for providing additional information about the author of a given prompt. For instance, the GUI may include an icon with the name of a participant alongside the icon. The icon may be clicked using a suitable input device to access additional information about the participant such as the participant's email, team, location, and so on. Profile service 450 may be used to associate sufficient information to associate a given prompt/response pair with a given participant. Such associations may be temporarily or persistently stored in a suitable memory device included in the data structure generation 460.

System 400 includes a data structure generation 460 component. Data structure generation 460 component may be used to generate data structures for use by client device 304 in displaying the collaborative interactions with conversational AI 330 in a chat-like interface. For example, data structure generation 460 component may include a memory device such as a database or a persistent key-value store that can store prompts and associated responses indexed with information that identifies, for example, a particular video conference during which the collaboration took place as well as the participants associated with particular prompts.

Data structure generation 460 component may generate and serialize a data structure upon request from web API 420 including some or all of the prompts and responses for a given conversation. For example, a suitable data structure format such as a JavaScript Object Notation (JSON) object may be used. The data structure may be populated by querying the memory device and adding the requested information to the structure ordered according to timestamp, including prompt/response text, formatting, associated profile information, and so on.

Data structure generation 460 component may use a memory device to generate transcripts of collections of prompts and responses, sometimes referred to as conversations. For example, the data structure generation 460 component may receive instructions to generate a transcript of a conversation or chat dialogue reflecting a team's collaboration from a previous date. The generated transcript may be annotated with information including information about the client device from which each prompt was received, information about the participant who submitted the prompt, and other information relevant to receipt of the transcript by the conversational AI 330. The transcript can then be sent to the conversational AI 330 to provide context to response to prompts during a new conversation.

Previous conversations can be used to provide context for other participants' collaborative efforts, subject to suitable security and privacy measures. For example, data structure generation 460 component may be used to provide a transcript of a previous conversation or chat dialogue from a first collaborative team to the conversational AI 330 to provide a basis for a new conversation for a second collaborative team. In such a case, each participant of the first collaborative team must first provide affirmative consent to the use of their conversation by the second collaborative team.

Turning next to FIG. 5, FIG. 5 shows an illustration of an example GUI 500 that may be used with a system for providing collaborative conversational AI during video conferencing. The example GUI 500 may be displayed, for example, on a screen or other display device included with client device 304. The example GUI 500 may be rendered based on a data structure received from the video conference provider 302 that includes information about prompts, responses, and associated participants, as generated, for instance, by the data structure generation 460 component described above.

Example GUI 500 portrays a video conferencing software client that can interact with a video conference provider, such as video conference provider 302, to allow a user to connect to the video conference provider 302, chat with other users, participate in a collaborative conversation with a conversational AI 330, or join virtual conferences. A client device, e.g., client device 304, executes a software client as discussed above, which in turn displays the GUI 500 on the client device's display.

In this example, the GUI 500 is shown with a chat view video layout 502 that present a gallery of participants 514 alongside a chat view 504. Gallery 514 may include some or all participants and may be ordered according to various criteria, like who spoke or typed most recently. Participant 515 is highlighted, in this example, to provide an indication that the participant is currently speaking or typing.

Beneath the chat view video layout 502 are a number of interactive elements 525-542 to allow the participant to interact with the virtual conference software. Controls 525-528 may allow the participant to toggle on or off audio or video streams captured by a microphone or camera connected to the client device. Control 530 allows the participant to view any other participants in the virtual conference with the participant, while control 532 allows the participant to send text messages to other participants, whether to specific participants or to the entire meeting. Control 534 allows the participant to share content from their client device. Control 535 allows the participant toggle recording of the meeting, and control 538 allows the user to select an option to join a breakout room. Control 540 allows a user to launch an app within the video conferencing software, such as to access content to share with other participants in the video conference. Control 542 allows a user to react or respond to an event during the video conference by, for example, expressing an emoji or raised hand icon visible by the other participants in the video conference.

Chat view 504 includes a representation of the collaborative conversation with conversational AI 330. In some examples, collaborating teams may have one or more concurrent collaborative conversations in progress. Chat view 504 includes a list 505 of conversations including the current and historical conversations. Historical conversations may be associated with a particular video conference, user, team, project, and so on.

A new conversation may be started with button 506. The chat log 509 includes prompt/response pairs 517, 516 that are associated with participants 512, 510, respectively. In some examples, one or more historical conversations from list 505 may be provided to the conversational AI 330 to provide context for a new conversation. For instance, a collaboration may take place among a team which is then archived. At a later date, the team may desire to continue the collaboration. A new conversation can be initiated, and the previous conversation can be provided to the conversational AI 330 as starting context for subsequent responses.

Participants 512, 510 are shown in example GUI 500 with an icon representing the participant, but any suitable text, colors, patterns, etc. may also be used. In some examples, the participants 512, 510 are themselves controls or buttons that can be clicked to obtain more information about the participant.

Prompt/response pairs 517/516 include prompts submitted by participants 512, 510 along with the response generated by conversational AI 330. Example GUI 500 includes an input box 508 that participants may create and edit new prompts for submission to conversational AI 330. In some examples, chat log 509 may display new prompts as they are being typed in real-time to promote the collaborative nature of the conversation.

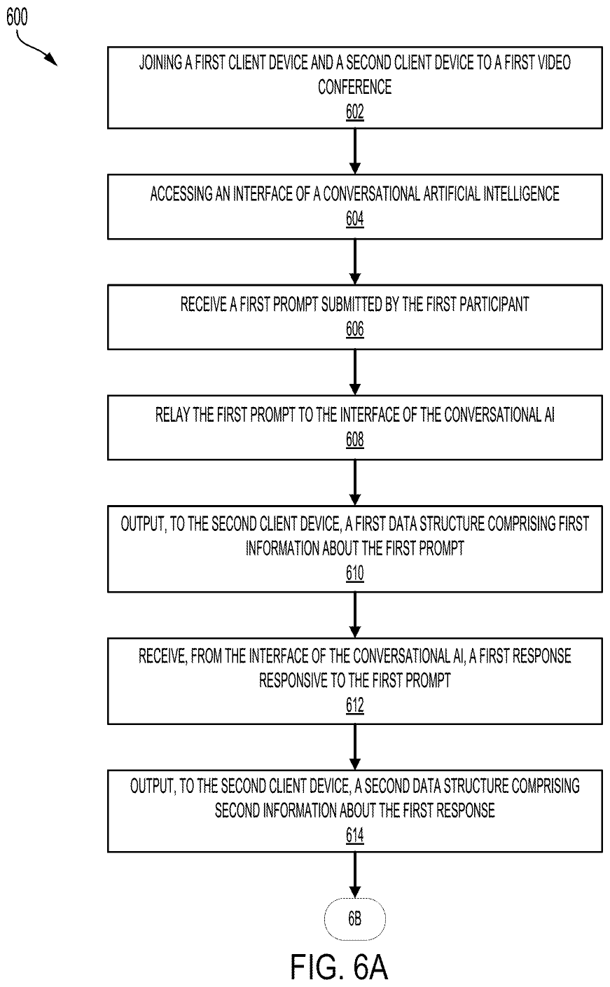

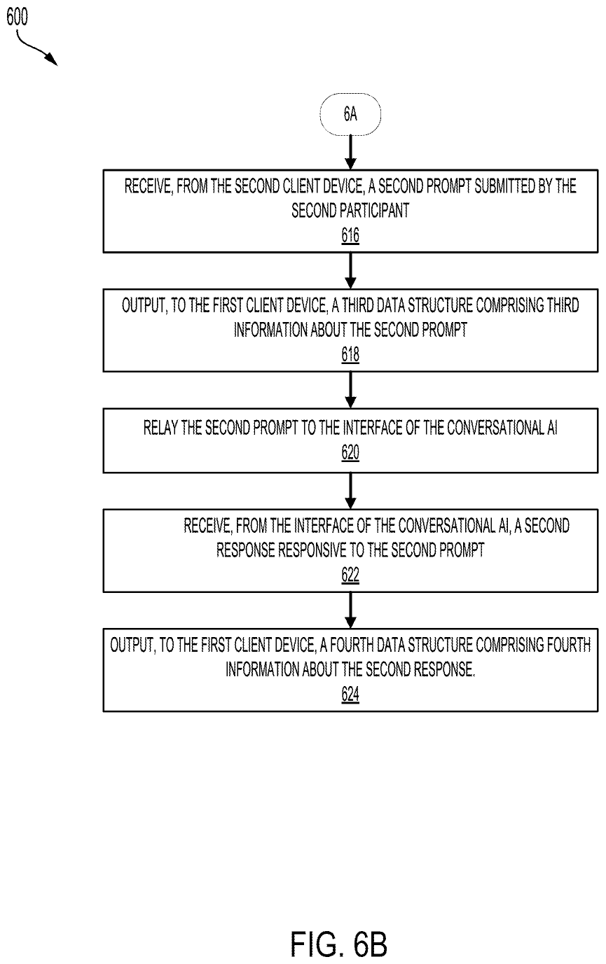

Referring now to FIGS. 6A-B, FIGS. 6A-B show a flowchart of an example method 600 for providing services for collaborative conversational AI during video conferencing, according to some aspects of the present disclosure. The description of the method 600 in FIGS. 6A-B will be made with reference to FIGS. 3-5, however any suitable system according to this disclosure may be used, such as the example systems 100 and 200, shown in FIGS. 1 and 2.

It should be appreciated that method 600 provides a particular method for providing services for collaborative conversational AI during video conferencing. Other sequences of operations may also be performed according to alternative examples. For example, alternative examples of the present disclosure may perform the steps outlined above in a different order. Moreover, the individual operations illustrated by method 600 may include multiple sub-operations that may be performed in various sequences as appropriate to the individual operation. Furthermore, additional operations may be added or removed depending on the particular applications. Further, the operations described in method 600 may be performed by different devices. For example, the description is given from the perspective of the video conference provider 302 but some embodiments of method 600 could be performed using client device 304. One of ordinary skill in the art would recognize many variations, modifications, and alternatives.

The method 600 may include block 602. At block 602, video conference provider 302 joins a first client device and a second client device to a first video conference, the first video conference having a first plurality of participants using a first plurality of client devices, the first client device associated with a first participant, and the second client device associated with a second participant. For example, the video conference provider 302 may provide an interface accessible using video conference client software for a first client device 304 to initiate a video conference. The first participant using the first client device 304 can invite other participants using other client devices, such as the second participant using the second client device 314. Once initiated, the video conference provider 302 may be used for planning, hosting, coordination of, and securing of the video conference, among other functions. The video conference provider 302, in effect, acts as a hub to coordinate the receipt and redistribution of video and audio streams between and among the participants to facilitate a seamless, real-time video conference user experience that closely mimics the experience of physically meeting together.

At block 604, video conference provider 302 accesses a conversational artificial intelligence (AI) 330. For example, video conference provider 302 may include a conversational AI interface 410 component for initiating, securing, and conducting communications with the conversational AI 330 as described in detail in FIG. 3 and the accompanying description. Initiating communications with conversational AI 330 may include authentication through an API provided by conversational AI 330 using a standard authentication protocol like OAuth2, SAML, etc. Once established, the communication session can be used for the sending of prompts and receipt of responses from conversational AI 330 for a plurality of concurrent conversations. For example, video conference provider 302 may manage a plurality of concurrent video conferences and each video conference may include one or more collaborative conversations with conversational AI 330. Thus, operation of each conversation using the API provided by conversational AI 330 may include tracking of timestamps, conversation IDs, video conference IDs, and information identifying the author of prompts. In some examples, a more than one conversation may be carried on concurrently in a single web request. In block 604, two-way communication with the conversational AI 330 is established and credentials (e.g., an access token) is ephemerally stored to facilitate ongoing access to the conversational AI 330.

At block 606, video conference provider 302 receives, from the first client device 304, a first prompt submitted by the first participant. For example, the first participant can use a GUI 500 similar to the one illustrated in FIG. 5 and the accompanying description to type or otherwise enter (e.g., using voice to text transcription) a prompt for transmission to conversational AI 330. Upon submission of the prompt to the web API 420 at video conference provider 302, the prompt may be received and processed by prompt processor 430 to prepare it for transmission to conversational AI 330. For instance, prompt processor 430 may remove whitespace, sanitize the prompt in accordance with certain security measures, or take privacy precautions.

At block 608, video conference provider 302 relays the first prompt to the conversational AI 330. For example, the video conference provider 302 may access an API provided by the conversational AI 330 and submit the prompt using a suitable API endpoint. In some examples, the API connection may be kept open while awaiting a response from conversational AI 330. In other examples, the transaction may be handled asynchronously. In one asynchronous example, the conversational AI 330 returns an identifier of the transaction (e.g., a random string) which can later be used to retrieve the response associated with the submitted prompt.

At block 610, video conference provider 302 outputs, to the second client device 314, a first data structure comprising first information about the first prompt. In some cases, block 610 may be performed in parallel with awaiting the response to the prompt sent in 608 to provide a near real-time experience to the participants in the collaborative conversation. Thus, the video conference provider 302 may send to the second client device 314 the prompt submitted by the first participant using the first client device 304 simultaneously with submission to the conversational AI 330. The second client device 314, upon receipt of a data structure containing the first prompt may use the data structure to populate a chat view video layout 504 as shown in FIG. 5. In some cases, the data structure may be sent to participating client devices 304, 314 and continuously as the participant types, so further enhance the user experience of real-time collaboration.

At block 612, video conference provider 302 receives, from the conversational AI, a first response responsive to the first prompt. As described above in block 608, the response to the prompt submitted by the first participant may be received synchronously or asynchronously with respect to the submission of the prompt. In a typical case, however, the response will be returned, even asynchronously, within a relatively short period of time after submission of the first prompt. The first response may be received, for example, within several seconds of submission of the first prompt. In some examples, the conversational AI 330 may return a partial response. For example, the conversational AI 330 may return a response one character at a time or several characters at a time. In some other examples, the entire first response may be received at one time.

At block 614, video conference provider 302 outputs, to the second client device 314, a second data structure comprising second information about the first response. For example, if the first response is received in its entirety, the entire first response may be sent to the second client device 314 which may again update the chat view video layout 504 to include the response underneath or otherwise physically close to the first prompt. In some examples, when the first response is sent piecemeal as described in block 612, the video conference provider 302 may output portions of the first response as it is received to present the appearance of real-time collaboration with other collaborative team members and with the conversational AI 330 itself.

In some examples, a similar process may be performed by other client devices participating in the video conference. For example, in blocks 616 through block 624, the process described in blocks 606 through 614 is repeated, except that the prompt is now received from the second client device 314, submitted by the second participant and the second prompt and second response are relayed to the first client device 304. In some examples, these operations by the first and second client devices 304, 314 may be performed simultaneously. In that example, the first participant may see the second participant preparing the second prompt while they are preparing the first prompt. Likewise, the second participant may see the first participant preparing the first prompt, as they prepare the second prompt. The GUI 500 of both participants may be updated immediately as the respective responses are received from conversational AI 330 in whole or in part. Both participants may thus have an experience of near real-time collaboration.

The method 600 can apply to a plurality of client devices in addition to first client device 304 and second client device 314. For example, if the first client device 304 and second client device 314 are among a plurality of client devices, the first prompt and response and the second prompt and response may be sent each of the remaining client devices of the plurality of client devices in real-time, such that each participant associated with each of the plurality of client devices sees the conversation between the participants and the conversational AI 330 as it unfolds.

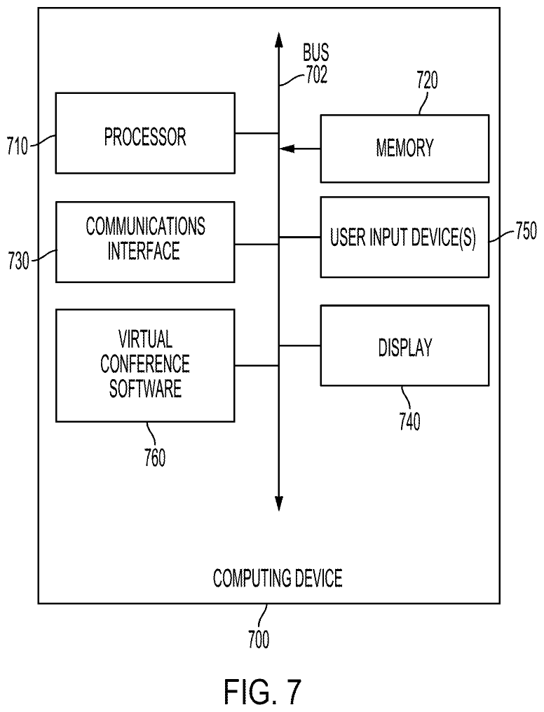

Referring now to FIG. 7, FIG. 7 shows an example computing device 700 suitable for use in example systems or methods for providing collaborative conversational artificial intelligence during video conferencing according to this disclosure. The example computing device 700 includes a processor 710 which is in communication with the memory 720 and other components of the computing device 700 using one or more communications buses 702. The processor 710 is configured to execute processor-executable instructions stored in the memory 720 to perform one or more methods for collaborative conversational artificial intelligence during video conferencing according to different examples, such as part or all of the example method 600 described above with respect to FIG. 6. The computing device 700, in this example, also includes one or more user input devices 750, such as a keyboard, mouse, touchscreen, microphone, etc., to accept user input. The computing device 700 also includes a display 740 to provide visual output to a user.

In addition, the computing device 700 includes virtual conferencing software 760 to enable a user to join and participate in one or more virtual spaces or in one or more conferences, such as a conventional conference or webinar, by receiving multimedia streams from a virtual conference provider, sending multimedia streams to the virtual conference provider, joining and leaving breakout rooms, creating video conference expos, etc., such as described throughout this disclosure, etc.

The computing device 700 also includes a communications interface 730. In some examples, the communications interface 730 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a method comprising: joining a first client device and a second client device to a first video conference, the first video conference having a first plurality of participants using a first plurality of client devices, the first client device associated with a first participant, and the second client device associated with a second participant; receiving, from the first client device, a first prompt submitted by the first participant; relaying the first prompt to a conversational artificial intelligence (AI); outputting, to the second client device, a first data structure comprising first information about the first prompt; receiving, from the conversational AI, a first response responsive to the first prompt; and outputting, to the second client device, a second data structure comprising second information about the first response.

Example 2 is the method of example(s) 1, further comprising: receiving, from the second client device, a second prompt submitted by the second participant; outputting, to the first client device, a third data structure comprising third information about the second prompt; relaying the second prompt to the conversational AI; receiving, from the conversational AI, a second response responsive to the second prompt; and outputting, to the first client device, a fourth data structure comprising fourth information about the second response.

Example 3 is the method of example(s) 2, wherein the second response responsive to the second prompt is further responsive to first prompt and the first response.

Example 4 is the method of example(s) 2, wherein the first prompt and the second prompt are included in a plurality of prompts, each prompt received from a client device of the first plurality of client devices and having an associated response, further comprising outputting, to the first plurality of client devices, a fifth data structure comprising the plurality of prompts and the response associated with each prompt of the plurality of prompts.

Example 5 is the method of example(s) 1 wherein: the first information about the first prompt comprises: information about the first client device; and information about the first participant; and the second information about the first response comprises: information about the first client device; and information about the first participant.

Example 6 is the method of example(s) 1, further comprising: receiving a plurality of prompts from the first plurality of client devices, each prompt of the plurality of prompts submitted by one of the first plurality of participants; receiving a plurality of associated responses from the conversational AI, each response responsive to a prompt from the plurality of prompts; generating a transcript including the plurality of prompts and the plurality of associated responses, wherein each prompt and each response is annotated with information comprising: information about a client device from which the prompt was received; and information about a participant who submitted the prompt; relaying the transcript to the conversational AI; joining a third client device to a second video conference, the second video conference having a second plurality of participants using a second plurality of client devices, the third client device associated with a third participant; receiving, from the third client device, a second prompt submitted by the third participant; relaying the second prompt to the conversational AI; and receiving, from the conversational AI, a second response responsive to the second prompt and the transcript.

Example 7 is the method of example(s) 1, further comprising: receiving a plurality of prompts and associated responses from the first plurality of client devices, wherein: each prompt of the plurality of prompts is submitted by one of the first plurality of participants; and the plurality of prompts and associated responses are associated with a plurality of conversational AI conversations; generating a transcript including the plurality of prompts and the associated responses from the plurality of conversational AI conversations, wherein each prompt and response is annotated with: information about a client device from which the prompt was received; and information about a participant who submitted the prompt; relaying the transcript to the conversational AI; joining a third client device to a second video conference, the second video conference having a second plurality of participants using a second plurality of client devices, the third client device associated with a third participant; receiving, from the third client device, an indication to begin a new conversational AI conversation; relaying the indication to begin the new conversational AI conversation to the conversational AI; receiving, from the third client device, a second prompt, wherein the second prompt is associated with the new conversational AI conversation; relaying the second prompt to the conversational AI; and receiving, from the conversational AI, a second response responsive to the second prompt and the transcript.

Example 8 is the method of example(s) 1, wherein the conversational AI is a transformer-based large language model, wherein the transformer-based large language model is a generative pre-trained transformer (GPT) model.

Example 9 is a non-transitory computer-readable medium storing instructions that, when executed by one or more processors, cause the one or more processors to perform operations including: joining a first client device and a second client device to a first video conference, the first video conference having a first plurality of participants using a first plurality of client devices, the first client device associated with a first participant, and the second client device associated with a second participant; accessing a conversational artificial intelligence (AI); receiving, from the first client device, a first prompt submitted by the first participant; relaying the first prompt to the conversational AI; outputting, to the second client device, a first data structure comprising first information about the first prompt; receiving, from the conversational AI, a first response responsive to the first prompt; and outputting, to the second client device, a second data structure comprising second information about the first response.

Example 10 is the non-transitory computer-readable medium of example(s) 9, further comprising: receiving, from the second client device, a second prompt submitted by the second participant; outputting, to the first client device, a third data structure comprising third information about the second prompt; relaying the second prompt to the conversational AI; receiving, from the conversational AI, a second response responsive to the second prompt; and outputting, to the first client device, a fourth data structure comprising fourth information about the second response.

Example 11 is the non-transitory computer-readable medium of example(s) 10, wherein the second response responsive to the second prompt is further responsive to first prompt and the first response.

Example 12 is the non-transitory computer-readable medium of example(s) 10, wherein the first prompt and the second prompt are included in a plurality of prompts, each prompt received from a client device of the first plurality of client devices and having an associated response, further comprising outputting, to the first plurality of client devices, a fifth data structure comprising the plurality of prompts and the response associated with each prompt of the plurality of prompts.

Example 13 is the non-transitory computer-readable medium of example(s) 9 wherein: the first information about the first prompt comprises: information about the first client device; and information about the first participant; and the second information about the first response comprises: information about the first client device; and information about the first participant.

Example 14 is the non-transitory computer-readable medium of example(s) 9, further comprising: receiving a plurality of prompts from the first plurality of client devices, each prompt of the plurality of prompts submitted by one of the first plurality of participants; receiving a plurality of associated responses from the conversational AI, each response responsive to a prompt from the plurality of prompts; generating a transcript including the plurality of prompts and the plurality of associated responses, wherein each prompt and each response is annotated with information comprising: information about a client device from which the prompt was received; and information about a participant who submitted the prompt; relaying the transcript to the conversational AI; joining a third client device to a second video conference, the second video conference having a second plurality of participants using a second plurality of client devices, the third client device associated with a third participant; receiving, from the third client device, a second prompt submitted by the third participant; relaying the second prompt to the conversational AI; and receiving, from the conversational AI, a second response responsive to the second prompt and the transcript.

Example 15 is the non-transitory computer-readable medium of example(s) 9, further comprising: receiving a plurality of prompts and associated responses from the first plurality of client devices, wherein: each prompt of the plurality of prompts is submitted by one of the first plurality of participants; and the plurality of prompts and associated responses are associated with a plurality of conversational AI conversations; generating a transcript including the plurality of prompts and the associated responses from the plurality of conversational AI conversations, wherein each prompt and response is annotated with: information about a client device from which the prompt was received; and information about a participant who submitted the prompt; relaying the transcript to the conversational AI; joining a third client device to a second video conference, the second video conference having a second plurality of participants using a second plurality of client devices, the third client device associated with a third participant; receiving, from the third client device, an indication to begin a new conversational AI conversation; relaying the indication to begin the new conversational AI conversation to the conversational AI; receiving, from the third client device, a second prompt, wherein the second prompt is associated with the new conversational AI conversation; relaying the second prompt to the conversational AI; and receiving, from the conversational AI, a second response responsive to the second prompt and the transcript.

Example 16 is the non-transitory computer-readable medium of example(s) 9, wherein the conversational AI is a transformer-based large language model, wherein the transformer-based large language model is a generative pre-trained transformer (GPT) model.

Example 17 is a system comprising a first client device, comprising: a display device; one or more processors; and one or more computer-readable storage media storing instructions which, when executed by the one or more processors, cause the one or more processors to perform operations including: joining a first video conference hosted by a video conference provider, the first video conference having a first plurality of participants using a first plurality of client devices including the first client device; outputting, by a first participant, to the video conference provider, a first prompt; receiving, from the video conference provider, first information about a first response generated by a conversational AI responsive to the first prompt; receiving, from the video conference provider, second information about a second prompt, and third information about a second response generated by the conversational AI responsive to the second prompt, the second prompt submitted by a second participant associated with a second client device; rendering a layout including the first prompt, the first response, the second prompt, and the second response, wherein: the first prompt and the first response comprise a first indication that is associated with the first client device and the first participant; and the second prompt and the second response comprise a second indication that is associated with the second client device and the second participant; and outputting a command to cause the layout to be displayed to the first participant on the display device of the first client device.

Example 18 is the system of example(s) 17, further comprising receiving a selection of a chat view video layout mode, wherein the rendered layout is configured to display the first prompt, the first response, the second prompt, and the second response as a chat dialogue.

Example 19 is the system of example(s) 17 wherein: the first information about the first response comprises: information about the first client device; and information about the first participant; the second information about the second prompt comprises: information about the second client device; and information about the second participant; and the third information about the second response comprises: information about the second client device; and information about the second participant.

Example 20 is the system of example(s) 17, wherein the conversational AI is a transformer-based large language model, wherein the transformer-based large language model is a generative pre-trained transformer (GPT) model.

That which is claimed is:

1. A method comprising:
joining a first client device and a second client device to a first video conference, the first video conference having a first plurality of participants using a first plurality of client devices, the first client device associated with a first participant, and the second client device associated with a second participant;
receiving, from the first client device, a first prompt submitted by the first participant;
relaying the first prompt to a conversational artificial intelligence (AI);
outputting, to the second client device, a first data structure comprising first information about the first prompt;
receiving, from the conversational AI, a first response responsive to the first prompt; and
outputting, to the second client device, a second data structure comprising second information about the first response.

2. The method of claim 1, further comprising:
receiving, from the second client device, a second prompt submitted by the second participant;
outputting, to the first client device, a third data structure comprising third information about the second prompt;
relaying the second prompt to the conversational AI;
receiving, from the conversational AI, a second response responsive to the second prompt; and
outputting, to the first client device, a fourth data structure comprising fourth information about the second response.

3. The method of claim 2, wherein the second response responsive to the second prompt is further responsive to first prompt and the first response.

4. The method of claim 2, wherein the first prompt and the second prompt are included in a plurality of prompts, each prompt received from a client device of the first plurality of client devices and having an associated response, further comprising outputting, to the first plurality of client devices, a fifth data structure comprising the plurality of prompts and the response associated with each prompt of the plurality of prompts.

5. The method of claim 1 wherein:
the first information about the first prompt comprises:
information about the first client device; and
information about the first participant; and
the second information about the first response comprises:
information about the first client device; and
information about the first participant.

6. The method of claim 1, further comprising:
receiving a plurality of prompts from the first plurality of client devices, each prompt of the plurality of prompts submitted by one of the first plurality of participants;
receiving a plurality of associated responses from the conversational AI, each response responsive to a prompt from the plurality of prompts;
generating a transcript including the plurality of prompts and the plurality of associated responses, wherein each prompt and each response is annotated with information comprising:
information about a client device from which the prompt was received; and
information about a participant who submitted the prompt;
relaying the transcript to the conversational AI;
joining a third client device to a second video conference, the second video conference having a second plurality of participants using a second plurality of client devices, the third client device associated with a third participant;
receiving, from the third client device, a second prompt submitted by the third participant;
relaying the second prompt to the conversational AI; and
receiving, from the conversational AI, a second response responsive to the second prompt and the transcript.

7. The method of claim 1, further comprising:
receiving a plurality of prompts and associated responses from the first plurality of client devices, wherein:
each prompt of the plurality of prompts is submitted by one of the first plurality of participants; and
the plurality of prompts and associated responses are associated with a plurality of conversational AI conversations;
generating a transcript including the plurality of prompts and the associated responses from the plurality of conversational AI conversations, wherein each prompt and response is annotated with:
information about a client device from which the prompt was received; and
information about a participant who submitted the prompt;
relaying the transcript to the conversational AI;
joining a third client device to a second video conference, the second video conference having a second plurality of participants using a second plurality of client devices, the third client device associated with a third participant;
receiving, from the third client device, an indication to begin a new conversational AI conversation;
relaying the indication to begin the new conversational AI conversation to the conversational AI;
receiving, from the third client device, a second prompt, wherein the second prompt is associated with the new conversational AI conversation;
relaying the second prompt to the conversational AI; and
receiving, from the conversational AI, a second response responsive to the second prompt and the transcript.

8. The method of claim 1, wherein the conversational AI is a transformer-based large language model, wherein the transformer-based large language model is a generative pre-trained transformer (GPT) model.

9. A non-transitory computer-readable medium storing instructions that, when executed by one or more processors, cause the one or more processors to perform operations including:
joining a first client device and a second client device to a first video conference, the first video conference having a first plurality of participants using a first plurality of client devices, the first client device associated with a first participant, and the second client device associated with a second participant;
accessing a conversational artificial intelligence (AI);
receiving, from the first client device, a first prompt submitted by the first participant;
relaying the first prompt to the conversational AI;
outputting, to the second client device, a first data structure comprising first information about the first prompt;
receiving, from the conversational AI, a first response responsive to the first prompt; and
outputting, to the second client device, a second data structure comprising second information about the first response.

10. The non-transitory computer-readable medium of claim 9, further comprising:
receiving, from the second client device, a second prompt submitted by the second participant;
outputting, to the first client device, a third data structure comprising third information about the second prompt;
relaying the second prompt to the conversational AI;
receiving, from the conversational AI, a second response responsive to the second prompt; and
outputting, to the first client device, a fourth data structure comprising fourth information about the second response.

11. The non-transitory computer-readable medium of claim 10, wherein the second response responsive to the second prompt is further responsive to first prompt and the first response.

12. The non-transitory computer-readable medium of claim 10, wherein the first prompt and the second prompt are included in a plurality of prompts, each prompt received from a client device of the first plurality of client devices and having an associated response, further comprising outputting, to the first plurality of client devices, a fifth data structure comprising the plurality of prompts and the response associated with each prompt of the plurality of prompts.

13. The non-transitory computer-readable medium of claim 9 wherein:
the first information about the first prompt comprises:
information about the first client device; and
information about the first participant; and
the second information about the first response comprises:
information about the first client device; and
information about the first participant.

14. The non-transitory computer-readable medium of claim 9, further comprising:
receiving a plurality of prompts from the first plurality of client devices, each prompt of the plurality of prompts submitted by one of the first plurality of participants;
receiving a plurality of associated responses from the conversational AI, each response responsive to a prompt from the plurality of prompts;
generating a transcript including the plurality of prompts and the plurality of associated responses, wherein each prompt and each response is annotated with information comprising:
information about a client device from which the prompt was received; and
information about a participant who submitted the prompt;
relaying the transcript to the conversational AI;
joining a third client device to a second video conference, the second video conference having a second plurality of participants using a second plurality of client devices, the third client device associated with a third participant;
receiving, from the third client device, a second prompt submitted by the third participant;
relaying the second prompt to the conversational AI; and
receiving, from the conversational AI, a second response responsive to the second prompt and the transcript.

15. The non-transitory computer-readable medium of claim 9, further comprising:
receiving a plurality of prompts and associated responses from the first plurality of client devices, wherein:
each prompt of the plurality of prompts is submitted by one of the first plurality of participants; and
the plurality of prompts and associated responses are associated with a plurality of conversational AI conversations;
generating a transcript including the plurality of prompts and the associated responses from the plurality of conversational AI conversations, wherein each prompt and response is annotated with:
information about a client device from which the prompt was received; and
information about a participant who submitted the prompt;
relaying the transcript to the conversational AI;
joining a third client device to a second video conference, the second video conference having a second plurality of participants using a second plurality of client devices, the third client device associated with a third participant;
receiving, from the third client device, an indication to begin a new conversational AI conversation;
relaying the indication to begin the new conversational AI conversation to the conversational AI;
receiving, from the third client device, a second prompt, wherein the second prompt is associated with the new conversational AI conversation;
relaying the second prompt to the conversational AI; and
receiving, from the conversational AI, a second response responsive to the second prompt and the transcript.

16. The non-transitory computer-readable medium of claim 9, wherein the conversational AI is a transformer-based large language model, wherein the transformer-based large language model is a generative pre-trained transformer (GPT) model.

17. A system comprising a first client device, comprising:
a display device;
one or more processors; and
one or more computer-readable storage media storing instructions which, when executed by the one or more processors, cause the one or more processors to perform operations including:
joining a first video conference hosted by a video conference provider, the first video conference having a first plurality of participants using a first plurality of client devices including the first client device;
outputting, by a first participant, to the video conference provider, a first prompt;
receiving, from the video conference provider, first information about a first response generated by a conversational AI responsive to the first prompt;
receiving, from the video conference provider, second information about a second prompt, and third information about a second response generated by the conversational AI responsive to the second prompt, the second prompt submitted by a second participant associated with a second client device;
rendering a layout including the first prompt, the first response, the second prompt, and the second response, wherein:
the first prompt and the first response comprise a first indication that is associated with the first client device and the first participant; and
the second prompt and the second response comprise a second indication that is associated with the second client device and the second participant; and
outputting a command to cause the layout to be displayed to the first participant on the display device of the first client device.

18. The system of claim 17, further comprising receiving a selection of a chat view video layout mode, wherein the rendered layout is configured to display the first prompt, the first response, the second prompt, and the second response as a chat dialogue.

19. The system of claim 17 wherein:
the first information about the first response comprises:
information about the first client device; and
information about the first participant;
the second information about the second prompt comprises:
information about the second client device; and
information about the second participant; and
the third information about the second response comprises:
information about the second client device; and
information about the second participant.

20. The system of claim 17, wherein the conversational AI is a transformer-based large language model, wherein the transformer-based large language model is a generative pre-trained transformer (GPT) model.
